(19) United States
(12) Patent Application Publication
(10) Pub. No.: US 2011/0083536 A1
(43) Pub. Date: Apr. 14, 2011

(54) Screwdriver with dual headed axial shaft

(76) Inventor: Douglas Palmisano, Pompano Beach, FL (US)

(21) Appl. No.: 12/924,900

(22) Filed: Oct. 7, 2010

Related U.S. Application Data
(60) Provisional application No. 61/278,885, filed on Oct. 14, 2009.

(51) Int. Cl. B25B 15/00; B25B 23/16

(52) U.S. Cl. 81/439

(57) ABSTRACT

A screwdriver with a dual headed axial shaft allows for easy alternation between two screwdriver heads while maintaining the traditional screwdriver design. An axial shaft member having two screwdriver heads located at opposite distal ends of the axial shaft member is sized to snuggly slide through a longitudinal channel extending between opposite ends of the screwdriver handle. A locking mechanism on the screwdriver handle serves to lock the axial shaft member within the screwdriver handle, thereby safely exposing one of the two screwdriver heads at a time. A user can then release the locking mechanism and slide the axial shaft member within the screwdriver handle, exposing the second screwdriver head at the opposite end of the axial shaft member. The shaft member is then locked into place by the automatically engaging locking mechanism.

### BACKGROUND OF THE INVENTION

This nonprovisional patent application is based on provisional patent application Ser. No. 61/278,885 filed on Oct. 14, 2009.

### FIELD OF THE INVENTION

The present invention relates to a handheld mechanical tool and, more particularly, to a screwdriver device having a handle and an accompanying axial shaft member with opposing screwdriver heads located at the distal ends of the axial shaft member, and wherein the shaft member slides within the handle to allow for easy alternation between the differing screwdriver heads.

### DISCUSSION OF THE RELATED ART

A screwdriver is a tool having an axial shaft with an affixed head that is used to engage and drive screws inwards with the application of torque, which the user creates by rotating the screwdriver. Typical manual screwdrivers include a cylindrical handle with an axial shaft protruding outwards from the handle. The axial shaft includes a head, which is formed into one of a variety of contours sized to engage a particular type of screw. The two predominant contours of screwdriver heads are the Phillips head design and the flat head design. Over the years, screwdrivers have been manufactured to include electric motors designed to rotate the screwdriver head, thereby applying torque electrically.

As a wide range of screw sizes and contours are required for various manufacturing purposes, a complete tool set often includes a number of uniquely sized individual screwdrivers, which can require a large amount of storage space. In an effort to limit the amount of space required to house a complete tool set, screwdrivers have been designed to utilize replaceable screwdriver head bits of differing size and contour that connect to a screwdriver's axial shaft. Given the wide range of different screws, however, a large amount of space is still required to house a complete set of replaceable screwdriver heads.

A number of attempts directed towards improving screwdrivers have been made in an effort to minimize the amount of storage space required to house a complete set of screwdrivers. For example, U.S. Pat. No. 7,757,589 discloses a screwdriver having a body that contains a plurality of slots for storing a plurality of screwdriver bits, each of which are sized to be affixed to the driveshaft of the screwdriver. Such a screwdriver device, however, often requires awkward fumbling of multiple screwdriver bits in order to alternate between different sizes and contours.

Other screwdriver devices have been designed to include multiple axial shafts, each of which features a different tool at each distal end. U.S. Pat. No. 5,685,207 discloses such a multipurpose tool, which includes two connected axial shafts, each of which include a particular tool on either end of each axial shaft, and allows for quick alternation between different tools. The design of such a device, however, makes it difficult for a user to apply torque to a screw located in a narrow space, as the user is unable to rotate the device due to the presence of the second axial shaft.

While the screwdriver devices described above are useful for their intended purpose, there remains a need for a more practical and efficient screwdriver device that allows for easy alternation between differing screwdriver heads. The present invention provides an axial shaft member having two screwdriver heads located at opposite distal ends of the axial shaft member, which is sized to snuggly slide within an elongate channel that extends longitudinally through a screwdriver handle. A locking mechanism on the screwdriver handle serves to lock the axial shaft member in place within the screwdriver handle, thereby safely exposing one of the two screwdriver heads at a time. A user can then release the locking mechanism and slide the axial shaft member within the screwdriver handle, exposing the second screwdriver head at the opposite end of the axial shaft member, which can then be locked into place by the locking mechanism.

### SUMMARY OF THE INVENTION

The present invention is directed to a screwdriver that allows the user to easily alternate between the use of two different screwdriver heads. The present invention includes an axial shaft member having two screwdriver heads located at opposite distal ends of the axial shaft member. The shaft member is sized to slide through an elongate channel that extends longitudinally through the screwdriver handle. The elongate channel is sized and configured to receive the shaft member with very little clearance, thereby allowing sliding movement of the shaft member through the handle without excess play or wobble. A locking mechanism on the screwdriver handle serves to lock the axial shaft member within the screwdriver handle, thereby safely exposing one of the two screwdriver heads at a time during use. A user can then release the locking mechanism and slide the axial shaft member within the screwdriver handle, exposing the second screwdriver head at the opposite end of the axial shaft member. The shaft member is then locked into place by the automatically engaging locking mechanism.

### BRIEF DESCRIPTION OF THE DRAWINGS

For a fuller understanding of the nature of the present invention, reference should be made to the following detailed description taken in conjunction with the accompanying drawings in which:

FIG. 1 is a perspective view showing the screwdriver device of the present invention in accordance with a preferred embodiment, wherein the screwdriver device includes a handle with an elongate channel extending through the length of the handle and communicating with opposite channel openings at opposite ends of the handle, and the screwdriver device further including a shaft member that snuggly slides through the elongate channel, the shaft member having opposing tool heads at opposite;

FIGS. 2A-2C show a side view of the screwdriver device and demonstrate a sequence of movement of the shaft member between two operable positions;

FIG. 3 is an exploded view of the screwdriver device showing the axial shaft member, a locking member, a recessed notch on the axial shaft member, and a spring for urging the locking member upwardly into engagement with the shaft member; and

FIGS. 4A and 4B show a cross-sectional view of the handle of the screwdriver device and the locking mechanism, and demonstrating operation of the release button of the locking mechanism to disengage the locking member from the shaft and thereby allowing sliding movement of the shaft through the elongate channel of the handle between a first operable position and a second operable position.

### DETAILED DESCRIPTION OF THE PREFERRED EMBODIMENTS

Referring to the several views of the drawings, the screwdriver with dual headed axial shaft is shown according to the several embodiments of the invention and is generally indicated as 10.

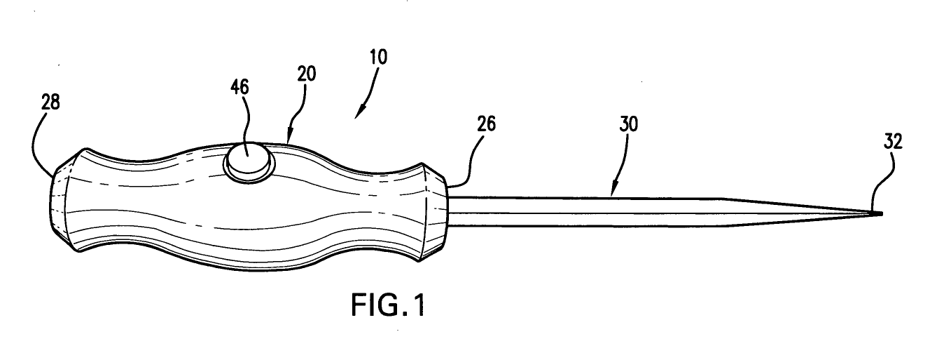

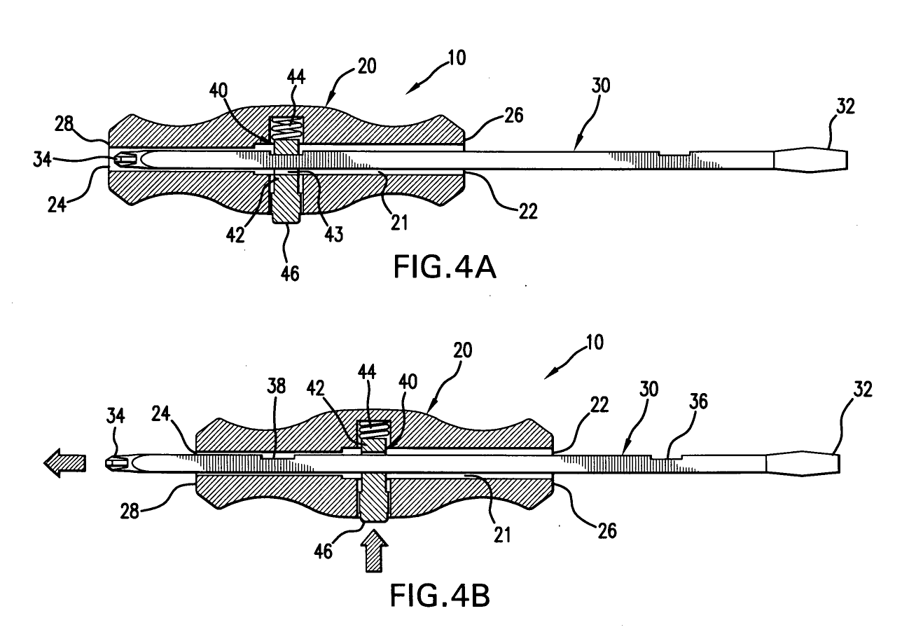

In each of the embodiments of the invention, the screwdriver 10 includes a handle 20 and an axial shaft member 30. Referring to FIGS. 1 and 4A-4B, the handle 20 is ergonomically shaped to be held within a user's hand and includes an elongate channel 21 extending throughout the length of the handle 20 between openings 22 and 24 at opposite ends 26, 28 of the handle 20. An axial shaft member 30 is sized to snuggly slide within the elongate channel 21 of the handle 20. The axial shaft member 30 includes a first distal end 32 and a second distal end 34, both of which include a particularly sized and contoured tool head. Recessed notches 36 and 38 are included along the length of the axial shaft member 30 engage with a locking member in order to lock the axial shaft member 30 into place prior to use.

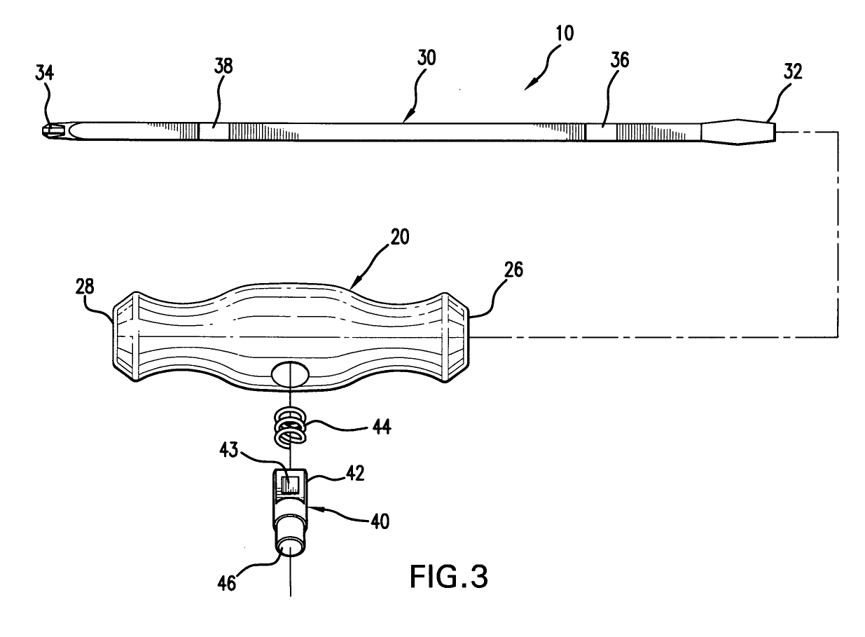

A locking mechanism 40, shown in detail in FIGS. 3-4B, serves to lock the axial shaft member 30 into place within the handle 20, keeping the axial shaft member 30 rigidly in place as vertical force and torque are applied to the screwdriver 10 during use. The locking mechanism 40 includes a locking member 42, a spring 44, and a release button 46. The locking member 42 has an aperture 43 that is sized for sliding passage of the axial shaft member 30 therethrough. As seen in figure s 4A-4B, the spring 44 is constantly urging the locking member 42 upwards, which provides the force necessary to secure the locking member 42 within one of the recessed notches 36 and 38. By applying enough downward (depression) force to the release button 46, which is affixed to the locking member 42, to overcome the force supplied by the spring 44, the locking member 42 is displaced out of the recessed notch 36 or 38, allowing the axial shaft member 30 slide freely through the aperture in the locking member 42 and the elongate channel of the handle 20.

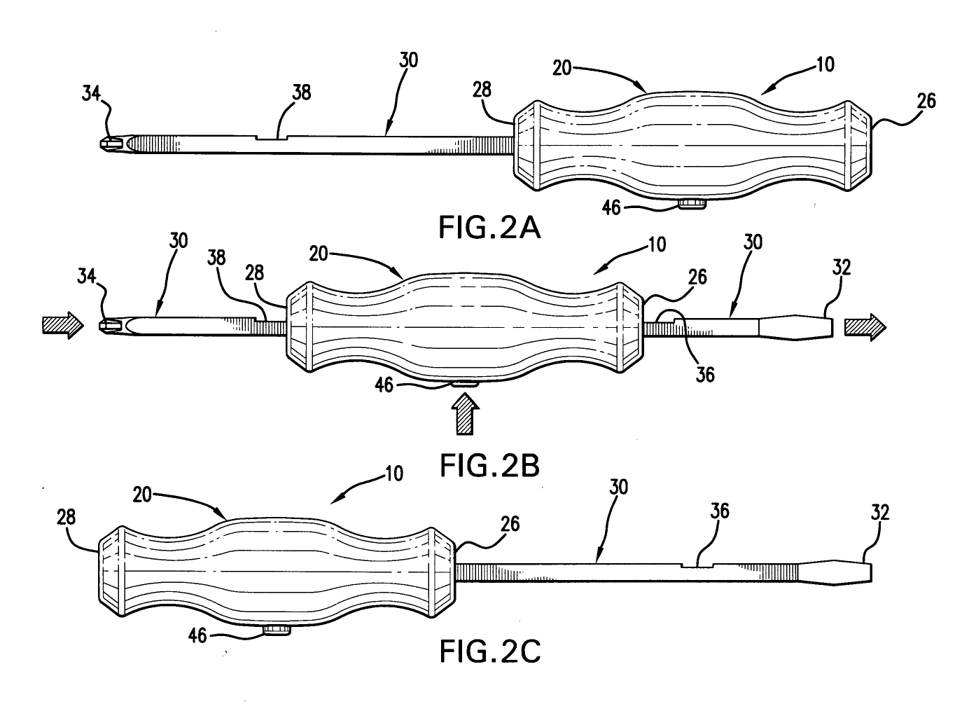

In operation, the user slides the axial shaft member 30 through the handle 20 until the axial shaft member 30 is automatically locked into place by the locking mechanism 40, exposing only the first end 32 of the axial shaft member 30 in a first operable position (see FIG. 2C and 4A). In order to utilize the second end 34 of the axial shaft member 30, the user applies downward pressure to the release button 46, which disengages the locking mechanism 40 and allows the user to slide the axial shaft member 30 through the elongate channel 21 of the handle 20. Once the locking member 42 clears the recessed notch (38) the user releases pressure from the button 46. The axial shaft member 30 is continually slid through the elongate channel 21 of the handle 20, as the spring 44 urges the locking member 42 against the shaft member 30, until the other recessed notch (36) reaches the locking member 42, at which point the spring 44 urges the locking member 42 into engagement within the recessed notch. This automatically locks the shaft member 30 into a second operable position (see FIG. 2A) wherein only the second tool end 34 is exposed for use, while the opposite tool end 32 is safely concealed within the handle.

While the present invention has been shown and described in accordance with several practical and preferred embodiments, it is recognized that departures from the instant disclosure are fully contemplated within the spirit and scope of the invention which is limited only by the following claims as interpreted by the Doctrine of Equivalents.

What is claimed is:

1. A screwdriver device comprising:
a handle having an elongate channel extending longitudinally throughout the length of said handle between channel openings at opposite ends of said handle;
an axial shaft member having a first distal end and a second distal end, and said axial shaft member being structured and disposed for sliding through said elongate channel of said handle;
a first tool head on the first distal end of said axial shaft member;
a second tool head on the second distal end of said axial shaft member; and
a locking mechanism structured and disposed for releasably locking said axial shaft member at a first operable position relative to said handle wherein said first tool head is exposed for use and said second tool head is concealed within said elongate channel, and a second operable position wherein said second tool head is exposed for use and said first tool head is concealed within said handle.

2. The screwdriver device as recited in claim 1 wherein said locking mechanism comprises:
a locking member having an opening sized to allow sliding passage of said axial shaft member therethrough;
a spring structured and disposed for constantly urging said locking member into engagement with said axial shaft; and
a release button moveable with said locking member, and said release button being structured and disposed for displacing said locking member from engagement with said shaft member and against the urging of said spring when said release button is operated by a user.

3. The screwdriver device as recited in claim 2 wherein said axial shaft member includes a pair of recessed notches structured and disposed for receiving said locking member.
